(19) United States
(12) Patent Application Publication
(10) Pub. No.: US 2012/0257804 A1
(43) Pub. Date: Oct. 11, 2012

(54) COMMUNICATIVE CAD SYSTEM FOR ASSISTING BREAST IMAGING DIAGNOSIS

(75) Inventors: Heidi Daoxian ZHANG, Los Gatos, CA (US); Patrick Bernard Heffernan, Los Gatos, CA (US)

(73) Assignee: THREE PALM SOFTWARE, Los Gatos, CA (US)

(21) Appl. No.: 13/368,063

(22) Filed: Feb. 7, 2012

Related U.S. Application Data
(63) Continuation of application No. 12/120,084, filed on May 13, 2008, now abandoned.
(60) Provisional application No. 60/930,132, filed on May 15, 2007.

(51) Int. Cl. G06K 9/00

(52) U.S. Cl. 382/128

(57) ABSTRACT

A method of reviewing medical images and clinical data to generate a diagnosis or treatment decision is provided. The method includes receiving the medical images and clinical data and processing the medical images and clinical data. The method also includes receiving concurrent data resulting from additional processing of the medical images and clinical data and processing the concurrent data using integrated machine learning algorithms to generate a diagnosis or treatment decision based on the processed concurrent data and processed medical images and clinical data.

This application claims priority to Provisional Application No. 60/930,132, filed on May 15, 2007. The present invention relates generally to the field of medical imaging systems. Particularly, the present invention relates to a method and apparatus for a communicative computational intelligence system for assisting breast imaging diagnosis in conjunction with a mammography CAD (Computer-aided diagnosis) server and a digital mammography workstation.

### BACKGROUND OF THE INVENTION

Early detection of breast cancer is the goal of mammography screening. With the rapid transition from film to digital acquisition and reading, more radiologists can benefit from advanced image processing and computational intelligence techniques if they can be applied to this task. The conventional approach is for such techniques to be embedded in a Computer Aided Detection (CAD) system that essentially operates off-line, and generates reports that can be viewed by a radiologist after un-aided reading (i.e., in a “second read” model). The off-line CAD reports usually provide only detection location coordinates and limited measurement and cancer likelihood information—but only at pre-defined regions or volumes of interest (ROI or VOI) that were determined during the CAD pre-processing. Examples of such off-line CAD pre-processing systems are discussed in U.S. Pat. No. 6,630,937 to Kailergi et al., and U.S. Pat. No. 6,944,330 to Novak et al. This constraint on the computer generated information that can be communicated between computer and human reader sometimes decreases the effective performance of the CAD system as well as that of human readers who use the CAD system, as is discussed in Joshua J. Fenton et al. “Influence of Computer-Aided Detection on Performance of Screening Mammography” New England Journal of Medicine, Volume 356:1399-1409, Apr. 5, 2007, Number 14.

Accordingly there is a need for a CAD system that allows real-time interaction between a human reader and the CAD system to provide improved results and improved readings of mammographic data and, thus, improved diagnoses and treatment decisions to patients.

### BRIEF SUMMARY OF THE INVENTION

Consistent with some embodiments, there is provided a computer-aided diagnosis (CAD) system for reviewing medical images and clinical data to generate a diagnosis or treatment decision. The system includes a CAD server configured to process the medical images and clinical data using integrated machine learning algorithms and a workstation coupled to the CAD server. Consistent with some embodiments, the workstation is configured to interact in real time with the CAD server facilitated by the integrated machine learning algorithms, and the CAD server and the workstation concurrently interact with the medical images and clinical data in real time to generate the diagnosis or treatment decision.

Consistent with some embodiments, there is also provided a method of reviewing medical images and clinical data to generate a diagnosis or treatment decision. The method includes receiving the medical images and clinical data and processing the medical images and clinical data. The method also includes receiving concurrent data resulting from additional processing of the medical images and clinical data and processing the concurrent data using integrated machine learning algorithms to generate a diagnosis or treatment decision based on the processed concurrent data and processed medical images and clinical data.

These and other embodiments will be described in further detail below with respect to the following figures.

### BRIEF DESCRIPTION OF THE SEVERAL VIEWS OF THE DRAWING

FIG. 1 is a diagram of a communicative computer-aided detection (CAD) system, according to some embodiments.

FIG. 2 is a flowchart illustrating a method of using the CAD system, according to some embodiments.

FIGS. 3A and 3B are diagrams illustrating the simultaneous viewing of a current and prior or baseline exam, consistent with some embodiments.

FIG. 4 is a flowchart illustrating the viewing workflow with the CAD system, consistent with some embodiments.

FIG. 5A is a flowchart illustrating a method of overall viewing of the images, consistent with some embodiments.

FIG. 5B illustrates an example of an overall view of current exam images and prior exam images.

FIG. 6A is a flowchart illustrating a method of systematic viewing of the images, consistent with some embodiments.

FIG. 6B illustrates an example of a systematic view of exam images.

FIG. 7A is a flowchart illustrating a method of all pixels magnify glass viewing of the images, consistent with some embodiments.

FIG. 7B illustrates an example of an all pixels view of exam images.

FIG. 8 is a flowchart illustrating a method for interpreting the findings generated viewing the images using the methods described in FIGS. 5A, 5B, 6A, 6B, 7A, and 7B, consistent with some embodiments.

FIG. 9 is a flowchart illustrating a specific example of an interpretation of a finding of a particular mass, consistent with some embodiments.

FIG. 10 is a flowchart illustrating a workflow between a CAD system and a radiologist, consistent with some embodiments.

### DETAILED DESCRIPTION OF THE INVENTION

Embodiments as disclosed herein may provide a computational intelligence (CI) method and apparatus to overcome the limitations from current CAD systems by providing a system that can be used interactively by a radiologist (i.e., in more of a “concurrent read” model). In particular, embodiments as disclosed herein may provide a CAD system that operates more like a very patient, indefatigable knowledge accumulating and communicating companion for the radiologist, rather than a second “expert” whose advice is sought after a normal review.

The system works interactively with the radiologist during image reading, prompting areas to review in more detail, providing computer generated features and interpretation, and suggesting potential diagnoses for areas of suspicion that are identified either by the machine or the human. In addition, the human can obtain more information from the system—the radiologist can query as to why a particular region is highlighted, or why a particular diagnosis is postulated for an area. Conversely, the system learns from the human—the radiologist identifies areas that should be marked, and updates the computer's knowledge of what the diagnosis should be for that area.

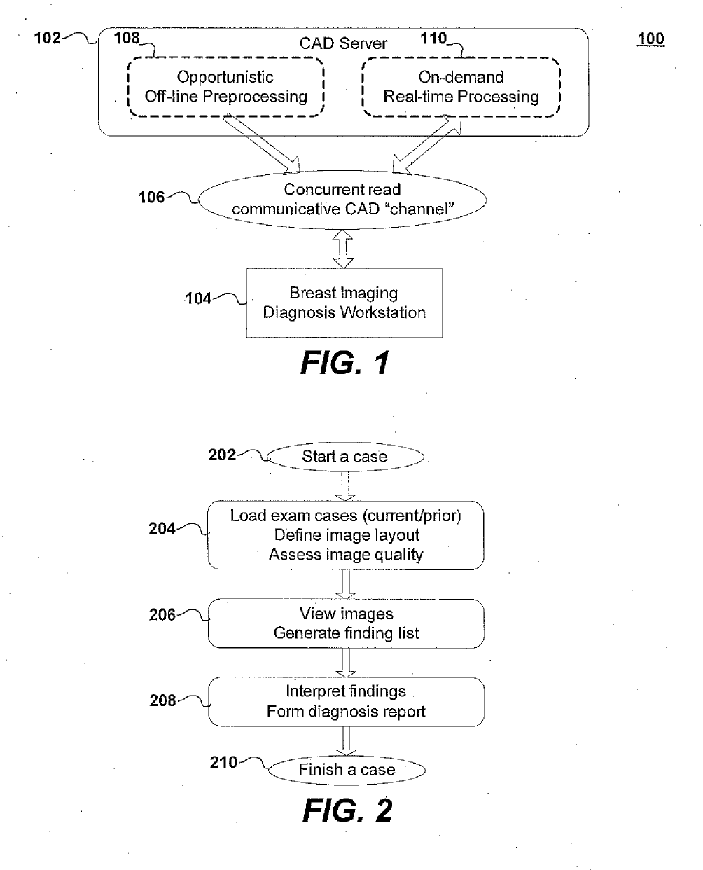

FIG. 1 is a diagram of a communicative computer-aided detection (CAD) system 100, according to some embodiments. As shown in FIG. 1, a CAD server 102 is coupled to a breast imaging diagnosis workstation 104 (“workstation”) via a concurrent read communicative CAD channel 106. A user, such as a radiologist, may interface with CAD server using workstation 104. CAD server 102 includes at least two types of processing available to a user: opportunistic off-line preprocessing 108 and on demand real-time processing 110. As shown in FIG. 1, channel 106 provides for bidirectional communication between workstation 104 and CAD server 102 for both types of processing.

The off-line CAD processing 108 generates CAD findings. Consistent with some embodiments, the off-line CAD performance is selected to operate at a performance point similar to average human reader in order to reduce distraction to human readers when using CAD findings, in particular, at a much higher specificity than current commercial CAD systems can provide. For example, off-line preprocessing 108 may operate at 70% sensitivity with 70% specificity, which is greater than the 40% offered by conventional products. So with much fewer false positive markers, instead of being used as a second read, CAD server 102 can play a role in concurrent reading. The off-line CAD processing also generates breast tissue segmentation and density assessment, pectoral muscle segmentation in the mediolateral oblique (MLO) views, and nipple position information.

The real-time CAD processing 110 provides more CAD information to readers during image review on workstation 104. The CAD information can be lesions segmentations, Breast Imaging-Reporting and Data System (BI-RADS) descriptor measurements and BI-RADS assessment to the findings from CAD server 102 and human readers at workstation 104.

FIG. 2 is a flowchart illustrating a method of using the CAD system 100, according to some embodiments. As shown in FIG. 2, the method begins when a case is started (202). Next, current and prior exam cases are loaded from CAD server 102 to workstation 104, the image layout is defined, and the image quality is assessed (204). Consistent with some embodiments, prior exam cases may include a baseline exam. The images associated with the exam cases are then viewed at workstation 104 and a list of findings is generated (206). The images may also include clinical metadata that may be viewed by the user of workstation 104. The listed findings may then be interpreted along with findings generated by off-line processing 108 of CAD server 102 for forming a diagnosis report (208).

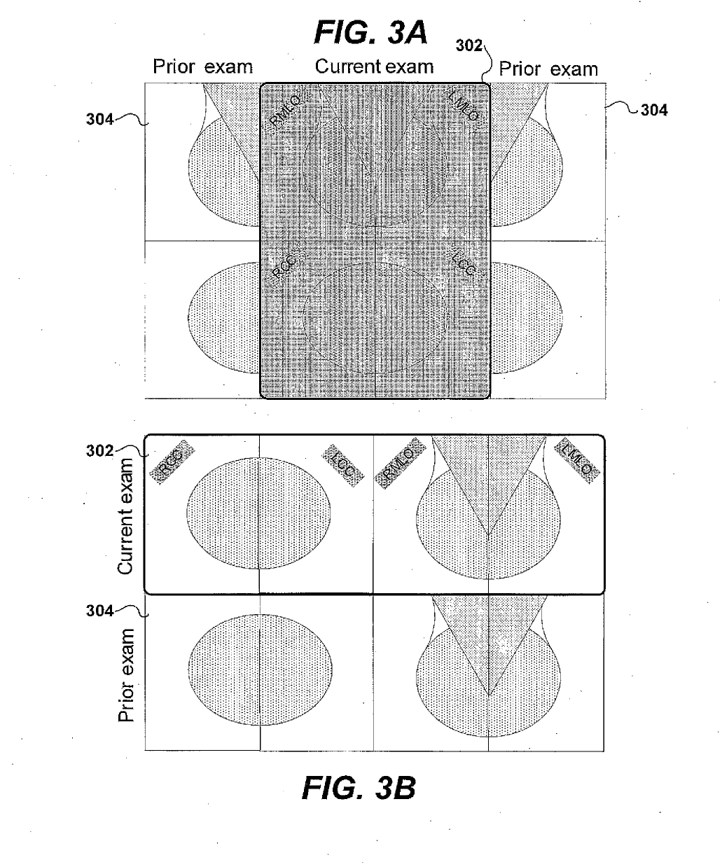

Consistent with some embodiments, within the loading and layout phase (204), the computer helps by: generating segmentations for the breast and the pectoral muscle, and the location of the nipple in each view. These segmentations are then used to clip out artifacts and to layout view images for viewing from chest wall to chest wall, as is shown in FIG. 3. Further consistent with some embodiments, while assessing quality, the computer helps to determine whether the images are of diagnostic quality with regard to positioning, exposure, and motion, because poor image quality or improper positioning often results in diagnostic errors. Moreover, when viewing images (206), if a prior or baseline exam is available, each image can be placed next to its counterpart from the current exam, either to the right/left or above/below. This convention helps systematic viewing of mammographic images.

FIGS. 3A and 3B are diagrams illustrating the simultaneous viewing of a current and prior or baseline exam, consistent with some embodiments. As shown in FIG. 3A, the current exam 302, including right (R) and left (L) mediolateral oblique (MLO) views and right and left craniocaudal (CC) views may be placed on the right or the left of a prior exam 304. As shown in FIG. 3B, the current exam 302 may also be placed above the prior exam. By placing the prior and current exam images side-by-side, or one below the other, a reader at workstation 104 may easily view both sets of images to more easily notice changes that occur between the past or baseline exam 304 and the current exam 302 and assist in the systematic viewing of mammographic images.

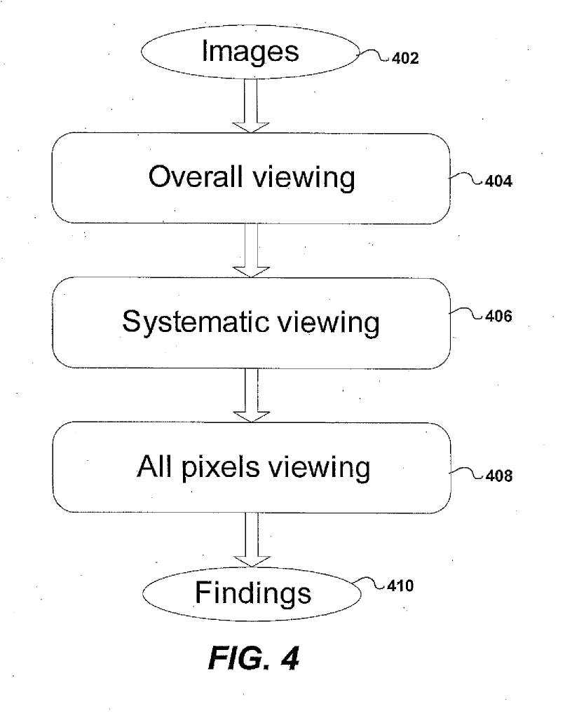

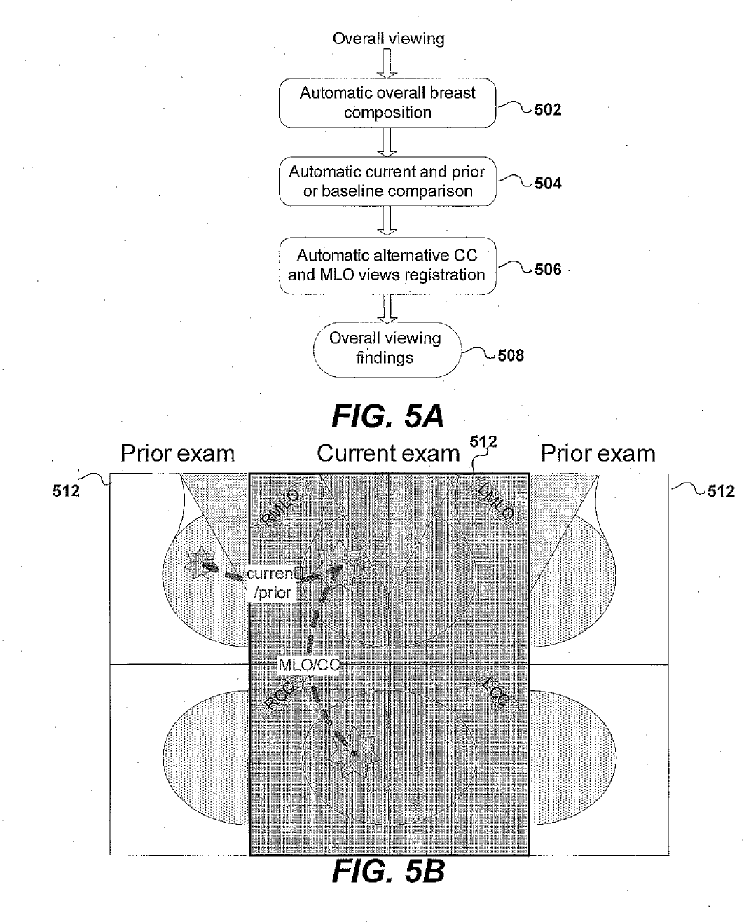

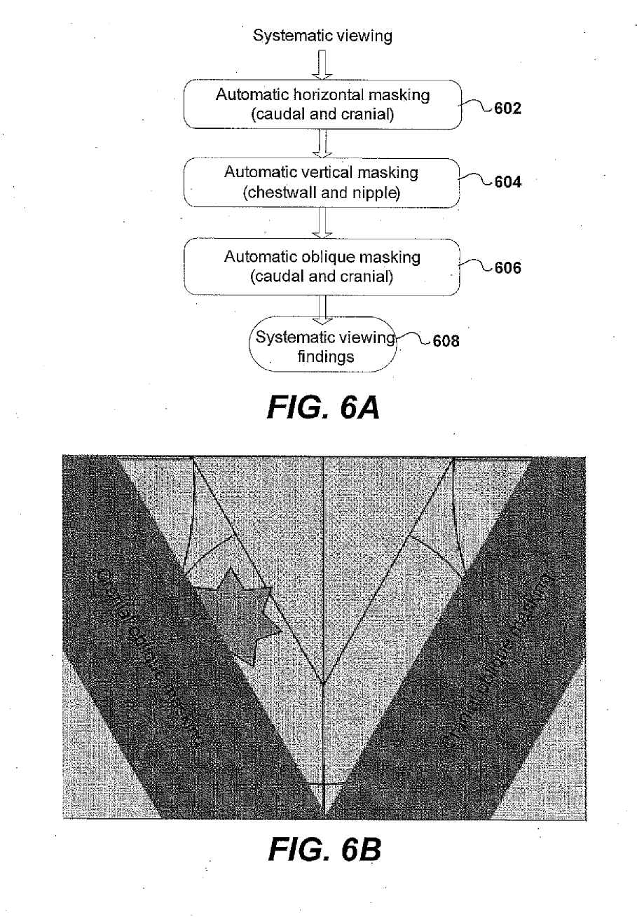

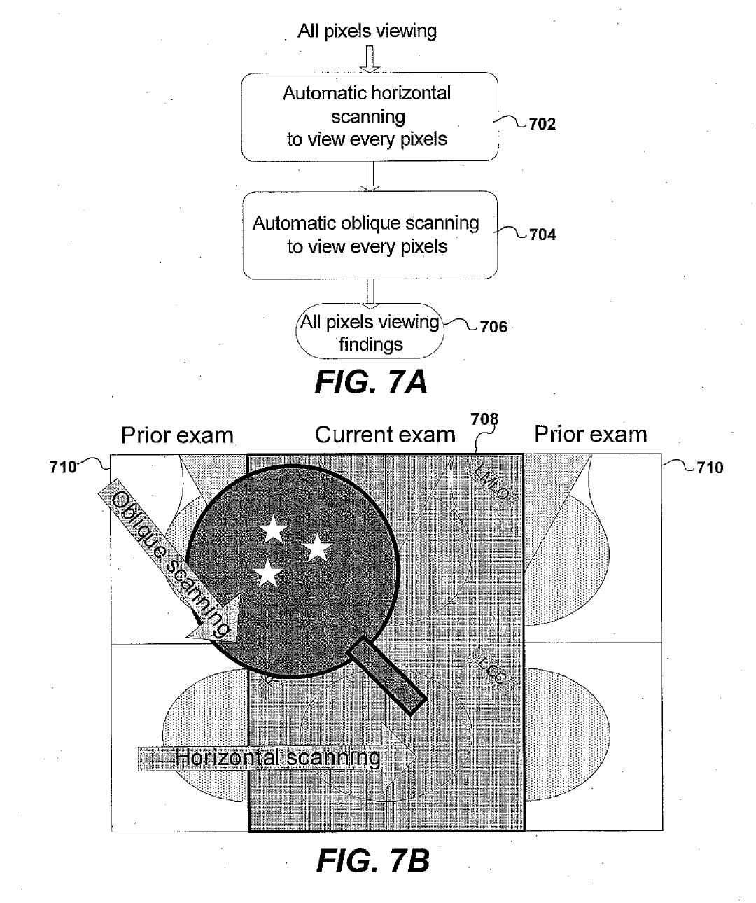

FIG. 4 is a flowchart illustrating the viewing workflow with the CAD system 100, consistent with some embodiments. As shown in FIG. 4, once the images are displayed at workstation 104 (402), the user first will engage in overall viewing of the images (404), which will be discussed further with respect to FIGS. 5A and 5B. The user may then engage in systematic viewing of the images (406), which will be discussed further with respect to FIGS. 6A and 6B, and then the user may engage in all pixels magnify glass viewing (408), which will be discussed further with respect to FIGS. 7A and 7B. The user may then record their findings (410).

FIG. 5A is a flowchart illustrating a method of overall viewing of the images, consistent with some embodiments. FIG. 5B illustrates an example of an overall view of current exam images and prior exam images. Overall viewing of current and prior views enhances the detection of tissue density changes; and overall viewing of caudocranial (CC) and mediolateral oblique (MLO) views enforces the detection on both view projections. As shown in FIG. 5A, a user at workstation 102 may be able to automatically process overall breast composition (502), current and prior or baseline comparison (504), and alternative caudocranial (CC) and mediolateral oblique (MLO) views (506) to generate overall viewing findings (508).

As shown in FIG. 5B, a user can compare a current exam image 510 to a prior exam image 512 and notice that a feature that is present in the right MLO image was also present in the prior exam, while there is a new feature noticeable in the right CC image. A user may also notice using overall viewing that the feature in the right MLO may appear larger in the current exam than in the previous exam image.

FIG. 6A is a flowchart illustrating a method of systematic viewing of the images, consistent with some embodiments. FIG. 6B illustrates an example of a systematic view of exam images. A detailed systematic perception comparison of left and right breasts using area masking, such as shown in FIGS. 6A and 6B, enhances the detection of structural asymmetries. Systematic viewing includes performing automatic horizontal masking (602), automatic vertical masking (604), and automatic oblique masking (606) to provide the systematic viewing findings (608). Consistent with some embodiments, the horizontal masking (602) may include caudal and cranial masking, the vertical masking (604) may include chestwall and nipple masking, and the oblique masking (606) may also include caudal and cranial masking. An example of cranial oblique masking is shown in FIG. 6B.

FIG. 7A is a flowchart illustrating a method of all pixels magnify glass viewing of the images, consistent with some embodiments. FIG. 7B illustrates an example of an all pixels view of exam images. Viewing with electronic magnifying glasses scanning through all pixels in the image allows a user to magnify pixels of the images and enhance the detection of microcalcifications. The all pixels viewing includes automatic horizontal scanning of all of the pixels (702) and automatic oblique scanning of all of the pixels (704) to generate findings (706). An example of this process is shown in FIG. 7B, wherein horizontal scanning (702) and oblique scanning (704) is performed on current exam images (708) and prior exam images (710).

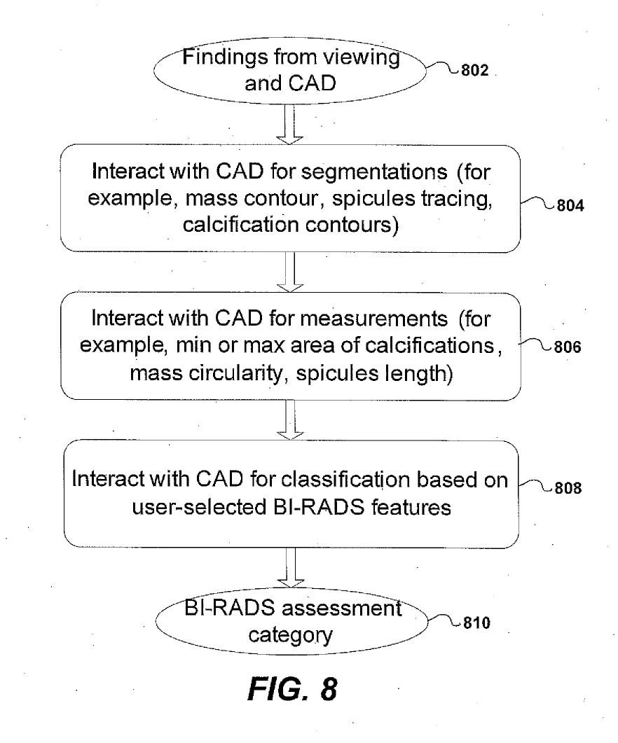

FIG. 8 is a flowchart illustrating a method for interpreting the findings generated viewing the images using the methods described in FIGS. 5A, 5B, 6A, 6B, 7A, and 7B, consistent with some embodiments. As discussed in FIG. 1 above, off-line preprocessing 108 may be combined with real-time processing 110, which may include findings generated viewing the images using the methods described in FIGS. 5A, 5B, 6A, 6B, 7A, and 7B, via concurrent read channel 106 (802). The user of workstation 104 may then interact with CAD server 102 to segment calcification or mass density regions and trace spicules (804). The user of workstation 104 may then interact with CAD server to extract measurements from the findings (806). The measurements may include a minimum or maximum area of the identified calcifications, a mass of any identified circularities, and lengths of any spicules. The user of workstation 104 may then further interact with CAD server 102 to classify the identified features based on user-selected Breast Imaging-Reporting and Data System (BI-RADS) features (808). Based on the classification, the features may then be identified based on a Breast Imaging-Reporting and Data System (BI-RAIDS) assessment category (810).

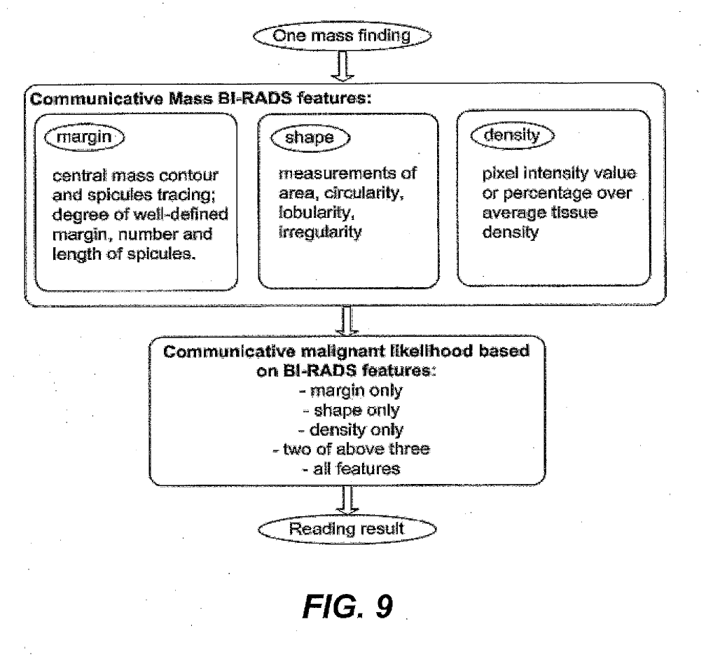

FIG. 9 is a flowchart illustrating a specific example of an interpretation of a finding of a particular mass, consistent with some embodiments. As shown in FIG. 9, once a mass has been found, features of the mass may be classified based on certain a Breast Imaging-Reporting and Data System (BI-RADS) assessment categories, including margin, shape, and density. Properties of the margin feature may include central mass contour and spicules tracing, a degree of a well-defined margin, and a number and length of spicules. Properties of the shape may include measurements of area, circularity, lobularity, and irregularity. Properties of the density may include a pixel intensity value or percentage over average tissue density. These properties of the margin, shape, and density of the mass may be communicatively determined through interpreting the findings generated viewing the images using the methods described in FIGS. 5A, 5B, 6A, 6B, 7A, and 7B, and combining off-line preprocessing and real-time processing, as discussed above. A user at workstation 104 in communication with CAD server 102 may then determine a likelihood of the mass being malignant based on any of the properties by themselves, or a combination of the properties.

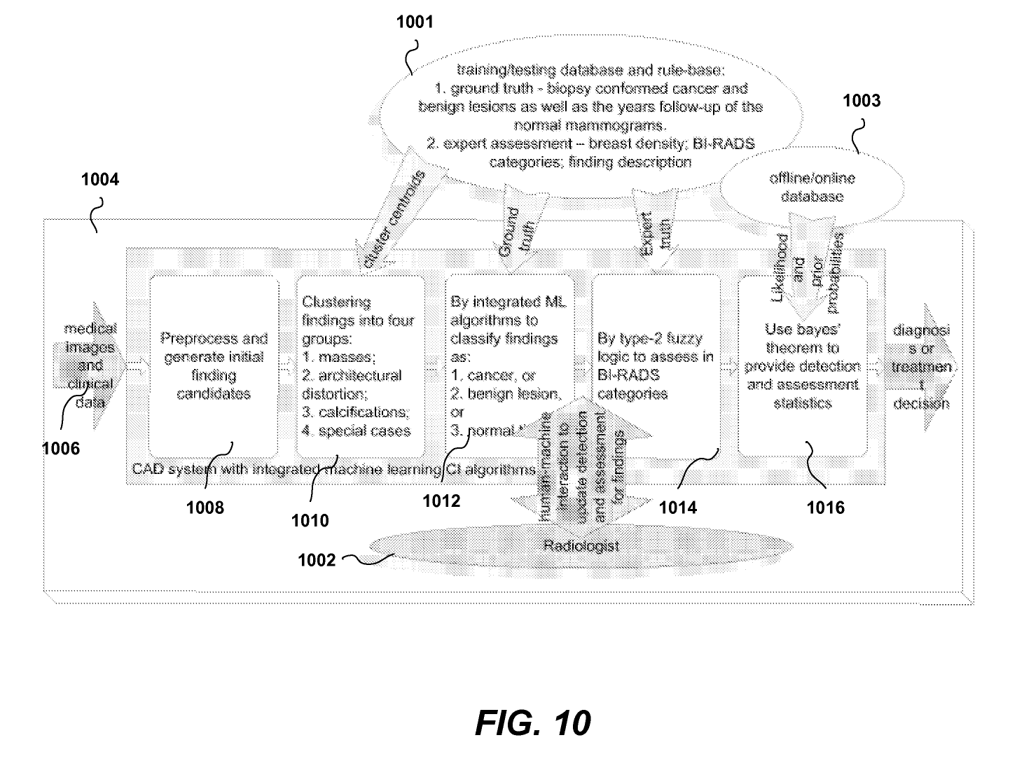

FIG. 10 is a flowchart illustrating a workflow between a CAD system and a radiologist, consistent with some embodiments. Although, the workflow illustrated in FIG. 10 is described in relation to mammography, the workflow between the radiologist 1002 and CAD system 1004 may also apply to reviewing ultrasound, magnetic resonance imaging, or computer-aided tomography images. As shown in FIG. 10, CAD system, which may correspond to CAD server 102 shown in FIG. 1, receives input from a training and testing database and rule base 1001 and an offline or online database 1003 in order to generate a diagnosis or treatment decision. The input is processed by logic and algorithms in the CAD system along with interactive, real-time input from a radiologist 1002 or user from workstation 104.

As shown in FIG. 10, medical images and clinical data 1006 are input into the CAD system 1002, and the CAD system 1002 preprocesses and generates initial finding candidates, or regions of interests, at 1008. The preprocessing and generation of findings may be performed consistent with determined through interpreting the findings generated viewing the images using the methods described in FIGS. 5A, 5B, 6A, 6B, 7A, and 7B, and combining off-line preprocessing and real-time processing, as discussed above. Based on integrated machine learning algorithms executed by CAD system 1004, interaction by radiologist 1002, and input of cluster centroids information from training and testing database 1001, the findings, or regions of interest may be clustered into one of four groups at 1010: 1) masses; 2) architectural distortion; 3) calcifications; and 4) special cases. After the findings or regions of interest have been clustered, the integrated machine learning algorithms executed by CAS system 1004 along with interaction by radiologist 1002, and input of “ground truth” from training/testing database 1001, the findings may be classified at 1012 as being cancerous, benign, or normal. Consistent with some embodiments, the “ground truth” may include biopsies of confirmed cancerous lesions, benign lesions, and past records of medical imaging. After the findings have been classified, the CAD system uses type-2 fuzzy logic to assess the classified findings in BI-RADS categories at 1014. This assessment also utilizes real-time radiologist 1002 interaction as well as assessment from an expert from training/testing database 1001, which may take into account breast density, Breast Imaging-Reporting and Data System (BI-RADS) categories, and the description of the findings up to this step of the process. The assessment may also be based, in part, on real-time interaction with radiologist 1002.

After the assessment is completed, CAD system 1004 may use a Bayesian analysis to provide detection and assessment statistics at 1016. The Bayesian analysis may also take into account likelihood and probability statistics from an offline or online database 1003, as well as real-time interaction with radiologist 1002. This analysis provides a basis for radiologist 1002 to provide a diagnosis or treatment decision to the patient.

Consistent with embodiments described herein, a computer-aided diagnosis system may utilize off-line preprocessing and on-demand real-time processing along with real-time concurrent analysis with a radiologist to provide improved analysis of mammographic images. The system works interactively with the radiologist during mammographic image reading, prompting areas to be reviewed in more detail, providing computer generated features and interpretation, and suggesting potential diagnoses for areas of suspicion that are identified either by the machine or the human. In addition, the radiologist can obtain more information from the system and the system can use integrated machine learning algorithms to learn from the radiologist. The examples provided above are exemplary only and are not intended to be limiting. One skilled in the art may readily devise other systems consistent with the disclosed embodiments which are intended to be within the scope of this disclosure. As such, the application is limited only by the following claims.

1. A computer-aided diagnosis (CAD) system for reviewing medical images and clinical data to generate a diagnosis or treatment decision, comprising:
a CAD server configured to process the medical images and clinical data using integrated machine learning algorithms; and
a workstation coupled to the CAD server, the workstation configured to interact in real time with the CAD server facilitated by the integrated machine learning algorithms, wherein:
the CAD server and the workstation concurrently interact with the medical images and clinical data in real time to generate the diagnosis or treatment decision.

2. The system of claim 1, wherein the CAD server is further configured to preprocess the medical images and clinical findings to generate findings.

3. The system of claim 2, wherein the CAD server is further configured to cluster the generated findings into distinct finding groups.

4. The system of claim 3, wherein the distinct finding groups comprise masses, architectural distortions, calcifications, and other special cases.

5. The system of claim 2, wherein the CAD server is further configured to classify the findings into discrete classifications using the integrated machine learning algorithms.

6. The system of claim 5, wherein the discrete classifications comprise cancer, benign, or normal.

7. The system of claim 2, wherein the CAD server is further configured to apply fuzzy logic to assess the Breast Imaging-Reporting and Data System (BI-RADS) category of the generated findings.

8. The system of claim 2, wherein the CAD server is further configured to perform Bayesian analysis on the generated findings to provide detection and assessment statistics regarding the generated findings.

9. The system of claim 1, wherein the CAD server is coupled to at least one external database configured to provide additional information to the CAD server, the additional information being used to generate the diagnosis or treatment decision.

10. The system of claim 1, wherein the CAD server and the workstation are further configured to review the medical images by performing an overall view, a systematic view using masking, and an all pixels view using an enhancement of each individual pixel comprising the medical images.

11. A method of reviewing medical images and clinical data to generate a diagnosis or treatment decision, comprising:
receiving, at a computer-aided detection (CAD) server, the medical images and clinical data;
processing, by the CAD server, the medical images and clinical data;
receiving, at the CAD server, concurrent data resulting from additional processing of the medical images and clinical data;
processing, by the CAD server, the concurrent data using integrated machine learning algorithms; and
generating, by the CAD server, a diagnosis or treatment decision based on the processed concurrent data and processed medical images and clinical data.

12. The method of claim 11, wherein processing the medical images and clinical data comprises:
viewing the medical images;
generating a findings list; and
interpreting the findings.

13. The method of claim 12, wherein viewing the medical images comprises:
performing an overall view of the medical images;
systematically viewing the medical images; and
viewing all of the pixels of the medical images.

14. The method of claim 13, wherein the medical images comprise mammographic images, and performing an overall view of the medical images comprises:
viewing a current mammographic image alongside a prior mammographic image;
determining an overall breast composition from the current mammographic image;
comparing the current mammographic image to the prior mammographic image; and
viewing the right and left caudocranial (CC) and mediolateral oblique (MLO) views of at least the current mammographic images.

15. The method of claim 13, wherein the medical images comprise mammographic images, and systematically viewing the medical images comprises:
viewing the mammographic images using a horizontal mask;
viewing the mammographic images using a vertical mask; and
viewing the mammographic images using an oblique mask.

16. The method of claim 13, wherein the medical images comprise mammographic images, and viewing all of the pixels of the medical images comprises magnifying every pixel of the mammographic images and:
horizontally scanning every magnified pixel of the mammographic images; and
obliquely scanning every magnified pixel of the mammographic images.

17. The method of claim 11, further comprising:
generating findings based on the processed concurrent data and processed medical images and clinical data;
clustering the findings into groups;
classifying the findings;
applying fuzzy logic to assess the Breast Imaging-Reporting and Data System (BI-RADS) category of the findings; and
performing Bayesian analysis on the findings to provide detection and assessment statistics regarding the findings.

18. The method of claim 11, wherein the received concurrent data is received from at least one of a radiologist at a workstation coupled to the CAD server, or an external database coupled to the CAD server.

19. The method of claim 11, wherein the additional processing of the medical images and clinical data is generated by a radiologist at a workstation coupled to the CAD server interacting in real time with the CAD server, the interaction comprising:
interacting with the CAD server to segment findings;
interacting with the CAD server to measure the segmented findings; and
interacting with the CAD server to classify the segmented findings based on user-selected Breast Imaging-Reporting and Data System (BI-RADS) features.

20. The method of claim 19, wherein:
segmenting the findings comprises identifying mass contours, tracing spicules, and identifying calcification contours; and
measuring the segmented findings comprises determining minimum or maximum areas of the identified calcification contours and length of the traces spicules.
